(19) United States
(12) Patent Application Publication
(10) Pub. No.: US 2026/0268382 A1
(43) Pub. Date: Sep. 10, 2026

(54) ARTIFICIAL INTELLIGENCE (AI)-BASED EVALUATION OF A SELLER-CONTESTED DISPUTE

(71) Applicant: eBay Inc., San Jose, CA (US)

(72) Inventors: Simran Bhagwandasani, Campbell, CA (US); Xiaochen Wang, Mountain View, CA (US); Jiansen Zhuo, Fremont, CA (US); Nagarajan Kanna, San Jose, CA (US); Myung Soo Kim, San Jose, CA (US)

(73) Assignee: eBay Inc., San Jose, CA (US)

(21) Appl. No.: 19/073,943

(22) Filed: Mar. 7, 2025

(51) Int. Cl. G06Q 30/0601; G06T 7/00

(52) U.S. Cl. CPC G06Q 30/0609; G06T 7/0004

(57) ABSTRACT

Artificial intelligence (AI)-based evaluation of a seller-contested dispute is described. A system may receive user input from a first user (e.g., a seller) indicating information related to a transaction dispute on an online marketplace that the seller is contesting. The information includes image and text evidence provided by the first user. A vision language model (VLM) capable of processing image and text data may generate a summary of the information, including a text description of the image evidence. A prompt may be generated based on the summary of the information, the prompt instructing a large language model (LLM) to evaluate the relevance of the evidence provided by the first user. Based on the prompt, the LLM may evaluate the relevance of the evidence and output a relevance score indicative of how relevant the evidence is to the first's user's dispute defense.

### BACKGROUND

Online marketplaces support and thus experience numerous and varied activities that facilitate transactions on the online marketplace. Some such activities may include a user (e.g., a seller) posting a listing of an item for sale, and a second user (e.g., a buyer) purchasing the item. In some examples, the buyer may dispute the transaction, for example, if the buyer believes the actual item they received is significantly different than the item that was listed for sale. In response, the seller may contest the dispute, for example, if the seller believes that the item listing accurately described the actual item that was purchased. Sellers may struggle with effectively contesting such disputes due to a lack of guidance on what constitutes strong evidence of their defense.

### SUMMARY

An artificial intelligence (AI)-based system for evaluating a seller-contested dispute is leveraged for an online marketplace. In one or more implementations, users may transact on an online marketplace, e.g., a buyer may purchase an item listed for sale on the online marketplace by the seller. The buyer may file a dispute to the transaction, and in response, the seller may file a contestation to the dispute. As a part of filing the contest, the seller may input information related to the contest, which may include some evidence of the seller's defense. The information may include image information (e.g., images of the item) and text information (e.g., a description of the item). For example, if the seller believes that the item sold was exactly as described, the seller may provide an image of the actual item (e.g., taken by the seller) and a stock image of the item to demonstrate similarities. The information may be provided to a vision language model (VLM), which may be trained to generate a summary of the information. The VLM may include a vision capability for processing image information as well as a natural language capability for generating a text summary of the image. That is, the summary may include details about the item (e.g., title, description, and so forth).

Based on the summary of the information, the system may utilize a fine-tuned prompt for an LLM to evaluate a relevance of the evidence included in the seller's contest. The prompt may include listing and dispute details, seller-provided image evidence of the sold item, a seller-provided contest note, and any other information relevant to the contested dispute. In addition, the prompt may instruct the LLM to evaluate the relevance of the evidence in the context of such information and determine whether the evidence is sufficient for the seller to effectively contest the dispute. The LLM may evaluate the evidence relevance based on the prompt and output a relevance score (e.g., ranging from 1 to 10, where a higher score indicates that the evidence is more likely to help the seller succeed in their contest). If the relevance score is below a threshold (e.g., under 5), indicating that the seller is unlikely to effectively contest the dispute with the current evidence, the LLM may output suggestions regarding how the seller may improve the relevance of the evidence tailored to the specific dispute in consideration for effective dispute resolution.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described in the accompanying figures.

FIG. 1 is an illustration of an environment in an example implementation that is operable to employ techniques described herein.

FIG. 2 depicts an example of a process for fine-tuning a VLM in accordance with aspects of the present disclosure.

FIG. 3 depicts an example of a fact generation process in accordance with aspects of the present disclosure.

FIG. 4 depicts an example of an evidence relevance evaluation process in accordance with aspects of the present disclosure.

FIG. 5 depicts an example of a user interface in accordance with aspects of the present disclosure.

FIG. 6 depicts a procedure in an example implementation of an AI-based evaluation of a seller-contested dispute in accordance with the aspects of the present disclosure.

FIG. 7 illustrates an example of a system that includes an example computing device that is representative of one or more computing systems and/or devices that may implement the various techniques described herein.

### DETAILED DESCRIPTION

### Overview

An AI-based system for evaluating seller-contested disputes on an online marketplace is described. In accordance with the described techniques, items may be available (e.g., listed) for sale on the online marketplace. The online marketplace may be accessible by decentralized computing devices that correspond to “clients” of the online marketplace, e.g., users that have accounts with the online marketplace. Users of the online marketplace may have some control over which items they list with or purchase from the online marketplace. For example, the users may determine when to list or purchase items, and may do so from different locations via a website or mobile application for the online marketplace. When a seller posts a lists an item for sale, the seller may include information about the item such as a title, a description, images and any other relevant information.

Buyers and sellers may transact on the online marketplace. In some examples, a buyer may purchase an item from the seller and subsequently file a dispute or chargeback related to the transaction for numerous reasons. For example, the buyer may dispute the transaction if the buyer believes the item they received is significantly different than the item listed. In response, the seller may contest or challenge the dispute. To file a contestation, the seller may be directed to input an explanation as to why the seller is contesting the dispute and upload supporting evidence related to their defense (e.g., documentation proving that the purchased item matches the listing description).

However, such disputes present significant challenges to sellers in the e-commerce industry. Despite being prompted to submit evidence via an image uploader and a text input field, sellers may struggle with effectively contesting disputes due to a lack of guidance on what constitutes strong, relevant evidence. That is, current dispute systems may merely prompt the seller for information about their challenge to a dispute without specifying what specific information may help the seller succeed. This often results in sellers providing insufficient or irrelevant information, reducing their chances of winning contested disputes. For example, the seller may submit poor-quality (e.g., blurry, black and white) images of the item, which may lead to a higher rate of lost disputes, directly causing financial losses for sellers as sellers are unable to recover funds from the transaction.

Moreover, the systems may lack any data storage or AI-based platform to assist in the dispute process, which may reduce the effectiveness and accuracy of dispute resolution. In addition, repeated failures to win such disputes may reduce sellers' confidence and trust in the online marketplace, and ultimately lead to sellers leaving the online marketplace. As a result, the online marketplace may experience monetary losses, reputation damage, and potential attrition of reliable sellers.

To address these limitations, techniques for AI-based evaluation of seller-contested disputes are described. In one or more implementations, the described techniques involve an evidence relevance platform, including a VLM and an LLM, implemented for an online marketplace. The LLM may support an LLM agent (also referred to herein as an AI assistant) designed to enhance the seller's experience and increase the likelihood of successful dispute contestation on the online marketplace. Using the LLM and the VLM, the evidence relevance platform may evaluate evidence submitted by the seller, including images and text descriptions, along with item details and reasons for the contestation. The LLM agent may assess whether the provided evidence is relevant (e.g., robust) enough to contest the dispute successfully. The LLM agent may also offer constructive guidance to improve the relevance and quality of the evidence, if applicable.

Specifically, the evidence relevance platform may receive information from a seller regarding their challenge to a disputed sale. The information may include listing details about the item at issue and evidence (e.g., reasoning and supporting documentation) related to the contestation. For example, the information may include image information (e.g., images of the item) and text information (e.g., a description of the item). A VLM may output a summary of the information provided by the seller to distill facts that are directly related to the seller's evidence. The VLM may include vision capability for processing image information as well as a natural language capability for processing text information to generate a text summary of the. Based on the summary of the information, a prompt may be provided to an LLM to evaluate a relevance of the evidence included in the seller's contest. The prompt may include fine-tuned listing and dispute details, seller-provided image evidence of the sold item, a seller-provided contest note, and any other information relevant to the dispute. In addition, the prompt may instruct the LLM to evaluate the relevance of the evidence in the context of such information and determine whether the evidence is sufficient for the seller to effectively contest the dispute. An LLM agent (e.g., AI assistant) supported by the LLM may evaluate the evidence relevance based on the prompt and output a relevance score (e.g., ranging from 1 to 10, where a higher score indicates that the evidence is more likely to help the seller succeed in their contest). If the relevance score is below a threshold (e.g., under 5), indicating that the seller is unlikely to effectively contest the dispute with the current evidence, the AI LLM agent may output suggestions regarding how the seller may improve the relevance of the evidence.

The described techniques may result in several improvements, including faster processing, improved data storage and data retrieval efficiency, and enhanced graphical user interface (GUI) features, among other improvements. For example, unlike manual or static methods, the described techniques may integrate LLMs and VLMs in such a way that dynamically analyzes visual and textual evidence to provide real-time, tailored feedback to sellers. The functionality of the LLMs and VLMs may thus improve data storage and data retrieval efficiency by processing both visual and textual evidence. Using the LLMs and VLMs to evaluate evidence relevance may also result in faster processing of the evidence (e.g., over manual evaluation) and subsequently, faster processing of disputes as sellers may submit the most relevant and robust evidence possible.

By integrating with existing systems (e.g., the online marketplace), the described platform may also store data (e.g., results of evidence evaluations, information about items listed on the online marketplace, and so forth), to continuously train the LLMs and VLMs and improve model accuracy over time. Moreover, the described techniques may enhance GUI features by utilizing an LLM agent to evaluate evidence relevance based on a prompt. The system may also be designed for efficient processing of large volumes of dispute cases, ensuring fast response times and scalability. In this way, the described techniques may assist sellers in strengthening their evidence, increasing the chance of successful dispute outcomes and reducing losses for sellers.

In some aspects, the techniques described herein relate to a computer-implemented method including: receiving, via a user input from a first user, information related to a dispute of a sale of an item on an online marketplace, wherein the information comprises evidence provided by the first user to contest the dispute; outputting, by a VLM, a summary of the information based on the information; providing a prompt to an LLM for evaluating a relevance of the evidence based on the summary of the information; and evaluating, by the LLM, the relevance of the evidence based on the prompt.

In some aspects, the techniques described herein relate to a computer-implemented method, further including outputting, by the LLM, a response to the prompt wherein the response indicates a relevance score and an explanation associated with the relevance.

In some aspects, the techniques described herein relate to a computer-implemented method, wherein a low relevance score indicates that the evidence is insufficient for the first user to effectively contest the dispute, and wherein a high relevance score indicates that the evidence is sufficient for the first user to effectively contest the dispute.

In some aspects, the techniques described herein relate to a computer-implemented method, further including generating, by the LLM, a suggestion for improving the relevance of the evidence based on a low relevance score.

In some aspects, the techniques described herein relate to a computer-implemented method, further including estimating, by the LLM, a likelihood that the first user would win the dispute based on the evidence and historical data.

In some aspects, the techniques described herein relate to a computer-implemented method, wherein evaluating the relevance of the evidence further includes assessing factors including at least image clarity, completeness, applicability to a reason for contesting the dispute, or consistency between the item itself and a listing description of the item.

In some aspects, the techniques described herein relate to a computer-implemented method, wherein the information further comprises listing details of the item, a listing image of the item, and a reason for contesting the dispute.

In some aspects, the techniques described herein relate to a computer-implemented method, wherein the prompt comprises one or more of listing details of the item, a listing image of the item, an evidence image of the item provided by the first user, a reason for disputing the sale provided by a second user, and a reason for contesting the dispute provided by the first user.

In some aspects, the techniques described herein relate to a computer-implemented method, wherein the reason for disputing the sale is that the item was significantly not as described.

In some aspects, the techniques described herein relate to a computer-implemented method, further including receiving, via a user input from a second user, an indication of the dispute, wherein the information is received in response to the indication.

In some aspects, the techniques described herein relate to a computer-implemented method, wherein the VLM comprises a vision encoder, a text encoder, and a fusion layer to integrate the information processed by the vision encoder and the text encoder.

In some aspects, the techniques described herein relate to a computer-implemented method, wherein the first user is a seller of the item and a second user is a buyer of the item on the online marketplace, and wherein the dispute is between the first user and the second user.

In some aspects, the techniques described herein relate to a system including: one or more processors; and memory storing instructions that, when executed by the one or more processors, cause the system to: receive, via a user input from a first user, information related to a dispute of a sale of an item on an online marketplace, wherein the information comprises evidence provided by the first user to contest the dispute; output, by a VLM, a summary of the information based on the information; provide a prompt to an LLM for evaluating a relevance of the evidence based on the summary of the information; and evaluate, by the LLM, the relevance of the evidence based on the prompt.

In some aspects, the techniques described herein relate to a system, wherein the instructions further cause the system to output, by the LLM, a response to the prompt wherein the response indicates a relevance score and an explanation associated with the relevance.

In some aspects, the techniques described herein relate to a system, wherein a low relevance score indicates that the evidence is insufficient for the first user to effectively contest the dispute, and wherein a high relevance score indicates that the evidence is sufficient for the first user to effectively contest the dispute.

In some aspects, the techniques described herein relate to a system, wherein the instructions further cause the system to generate, by the LLM, a suggestion for improving the relevance of the evidence based on a low relevance score.

In some aspects, the techniques described herein relate to a computer-implemented method, system, wherein the instructions further cause the system to estimate, by the LLM, a likelihood that the first user would win the dispute based on the evidence and historical data.

In some aspects, the techniques described herein relate to a computer-implemented method, system, wherein the instructions to evaluate the relevance of the evidence further cause the system to assess factors including at least image clarity, completeness, applicability to a reason for contesting the dispute, or consistency between the item itself and a listing description of the item.

In some aspects, the techniques described herein relate to a system, wherein the information further comprises listing details of the item, a listing image of the item, and a reason for contesting the dispute.

In some aspects, the techniques described herein relate to a system, wherein the prompt comprises one or more of listing details of the item, a listing image of the item, an evidence image of the item provided by the first user, a reason for disputing the sale provided by a second user, and a reason for contesting the dispute provided by the first user.

In some aspects, the techniques described herein relate to a system, wherein the reason for disputing the sale is that the item was significantly not as described.

In some aspects, the techniques described herein relate to a system, wherein the instructions further cause the system to receive, via a user input from a second user, an indication of the dispute, wherein the information is received in response to the indication.

In some aspects, the techniques described herein relate to a system, wherein the VLM comprises a vision encoder, a text encoder, and a fusion layer to integrate the information processed by the vision encoder and the text encoder.

In some aspects, the techniques described herein relate to a system, wherein the first user is a seller of the item and a second user is a buyer of the item on the online marketplace, and wherein the dispute is between the first user and the second user.

In some aspects, the techniques described herein relate to a non-transitory computer-readable media storing instructions that, when executed by one or more processors, cause the one or more processors to perform operations including: receiving, via a user input from a first user, information related to a dispute of a sale of an item on an online marketplace, wherein the information comprises evidence provided by the first user to contest the dispute; outputting, by a vision language model (VLM), a summary of the information based on the information; providing a prompt to a large language model (LLM) for evaluating a relevance of the evidence based on the summary of the information; and evaluating, by the LLM, the relevance of the evidence based on the prompt.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

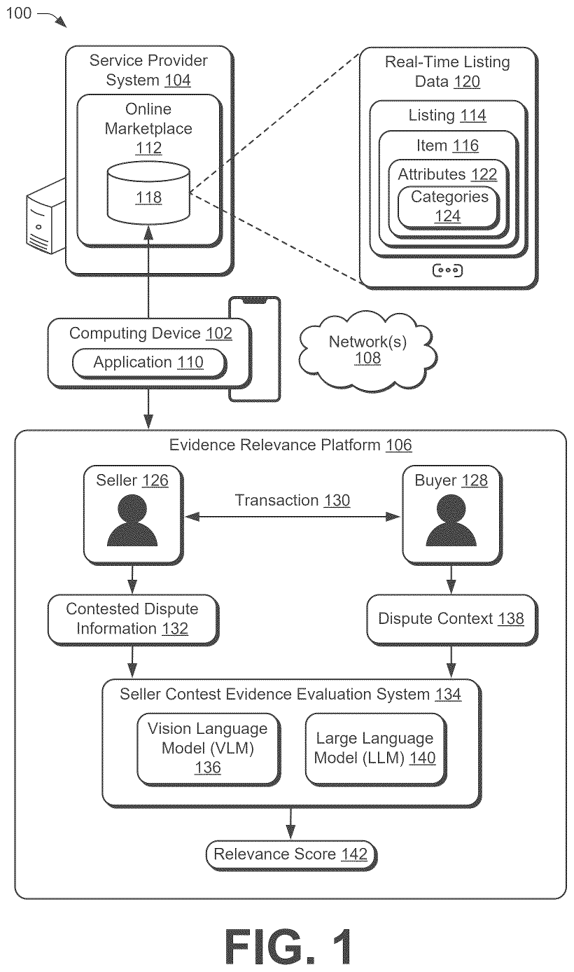

FIG. 1 is an illustration of an environment 100 in an example implementation that is operable to employ techniques described herein. The environment 100 includes a computing device 102, a service provider system 104, and an evidence relevance platform 106. In one or more implementations, the computing device 102, the service provider system 104, and the evidence relevance platform 106 are communicatively coupled, one to another, via network(s) 108. One example of the network(s) 108 is the Internet, although one or more of the computing device 102, the service provider system 104, and the evidence relevance platform 106 may be communicatively coupled using one or more different connections or different networks in various implementations (e.g., a cloud).

Although the evidence relevance platform 106 is depicted in the environment 100 as being separate from the computing device 102 and the service provider system 104, in one or more implementations, an entirety or various portions of the evidence relevance platform 106 are implemented at or by the computing device 102 and/or the service provider system 104. In at least one implementation, for example, at least a portion of the evidence relevance platform 106 is implemented by an application 110 of the computing device 102 and/or using various resources of the computing device 102, such as hardware resources, an operating system, firmware, and so forth. Additionally, or alternatively, at least a portion of the evidence relevance platform 106 is implemented by resources (e.g., server-based storage, processing, and so on) of the service provider system 104. Additionally, or alternatively, at least a portion of the evidence relevance platform 106 is implemented using a third-party service, such as a web services platform that provides one or more hardware and/or other computing resources to support provision of services by web service providers.

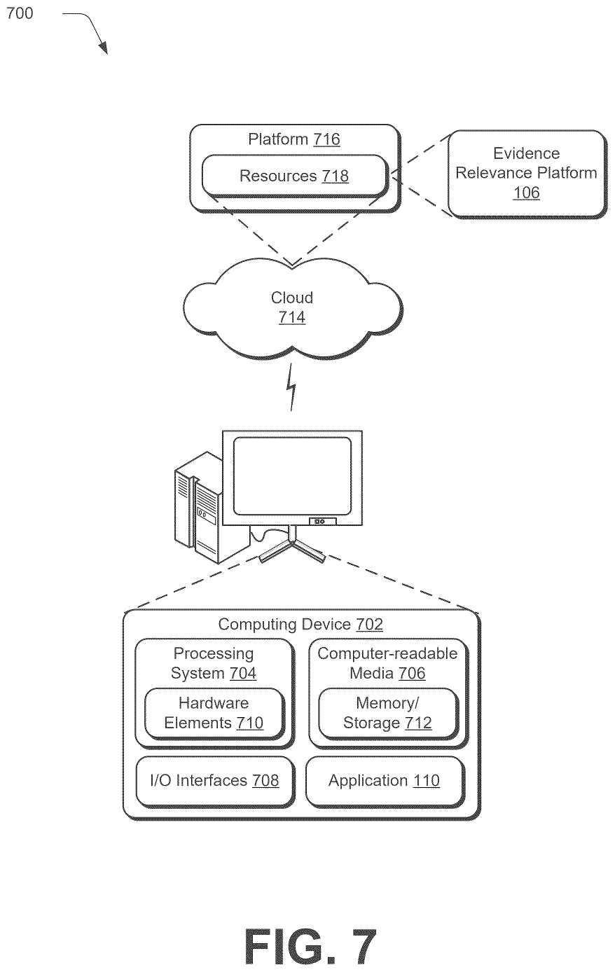

Computing devices that implement the environment 100 are configurable in a variety of ways. A computing device (e.g., computing device 102), for instance, is configurable as a desktop computer, a laptop computer, a mobile device (e.g., assuming a handheld configuration such as a tablet or mobile phone), an Internet-of-Things (IOT) device, a wearable device (e.g., a smart watch, a ring, or smart glasses), an augmented reality (AR)/virtual reality (VR) device (e.g., smart glasses), a server, and so forth. Thus, a computing device ranges from full resource devices with substantial memory and processor resources to low-resource devices with limited memory and/or processing resources. Additionally, although reference is made to a computing device in the singular, a computing device is also representative of a plurality of different devices, such as multiple servers of a server farm or data center utilized to perform operations “over the cloud” as further described in relation to FIG. 7.

In at least one implementation, the application 110 supports communication of data across the network(s) 108, such as between the computing device 102 and the service provider system 104 and/or between the computing device 102 and the evidence relevance platform 106. By supporting such data communication, the application 110 provides a respective user of the computing device 102 (and users of other computing devices) access to online marketplace 112. For example, the computing device 102 receives data from the service provider system 104. Based on the received data, the application 110 causes various systems of the computing device 102 to output user interfaces of the online marketplace 112, such as by displaying user interfaces via display devices or making accessible voice-based user interfaces.

Through interaction of a user with the computing device 102, the application 110 receives user input via one or more user interfaces of the online marketplace 112 and/or evidence relevance platform 106. Examples of such input include, but are not limited to, receiving touch input in relation to portions of a displayed user interface, receiving one or more voice commands, receiving typed input (e.g., via a physical or virtual (“soft”) keyboard), receiving mouse or stylus input, and so forth. One example of the application 110 is a browser, which is operable to navigate to a website of the online marketplace 112, display pages of the website, facilitate user interaction with web pages of the online marketplace 112's website, and search for listings, items, and/or functionality of the online marketplace 112. Another example of the application 110 is a web-based computer application of the online marketplace 112, such as a mobile application or a desktop application. The application 110 may be configured in different ways, which enable users to interact with their computing devices and by extension perform actions on the online marketplace 112, without departing from the spirit or scope of the techniques described herein.

In one or more implementations, users register with the service provider system 104 to obtain respective user accounts with the online marketplace 112. Such registration may include, for instance, providing an email address and establishing a username and password combination. Subsequent to registering with the service provider system 104, computing devices (e.g., the computing device 102) facilitate signing into, or otherwise authenticating to, the user account in various ways, such as by receiving a username and matching password, receiving biometric information (e.g., at least one image captured of a face or information captured of another body part such as a thumb or finger) that suitably matches stored biometric information associated with the user account, and so forth. In at least some scenarios, however, the user account via which a user accesses the online marketplace 112 may be a guest account that does not require a user to sign in or otherwise authenticate to an already established account before interacting with the online marketplace 112.

Broadly speaking, the online marketplace 112 is configured to generate listings 114 for items 116 and to expose those listings 114 (e.g., publish them) across the network(s) 108 to one or more computing devices, including to the computing device 102. For example, the online marketplace 112 may generate listings 114 for items 116 for sale and expose those listings to computing devices, such that users of the computing devices can interact with the listings via user interfaces to initiate transactions (e.g., purchases, add to wish lists, share, and so on) in relation to the respective item 116 or items 116 of the listings. In accordance with the described techniques, the items 116 include one or more types of physical goods or property (e.g., clothing and/or clothing accessories, jewelry, collectibles, furniture, decorative items, textiles, luxury items, electronics, real property, physical computer-readable storage having one or more video games or other digital content stored thereon, and so on), services (e.g., babysitting, dog walking, house cleaning, home repair, general contracting, and so on), digital items (e.g., digital images, digital music, digital videos) that can be downloaded via the network(s) 108, and blockchain backed assets (e.g., non-fungible tokens (NFTs)), to name just a few.

In the environment 100, the online marketplace 112 includes a storage device 118, which is depicted as maintaining real-time listing data 120. The real-time listing data 120 includes a plurality of listings 114 of the online marketplace 112. The storage device 118 may represent one or more databases and/or other types of storage capable of storing the real-time listing data 120. Examples of the storage device 118 include, but are not limited to, mass storage and virtual storage. In one or more implementations, for example, the storage device 118 may be virtualized across a plurality of data centers and/or cloud-based storage devices. The service provider system 104 may implement the online marketplace 112 by using servers that execute stored instructions to deploy various services of the service provider system 104, such that those services perform numerous computations which are effective to provide the functionality described above and below. It is to be appreciated that the online marketplace 112 may include more, fewer, or different components without departing from the spirit or scope described herein.

In one or more implementations, the online marketplace 112 is accessible by decentralized computing devices that correspond to “clients” of the online marketplace 112, e.g., users that have accounts with the online marketplace 112 and/or that access the online marketplace as a “guest” that is not signed to such an account or tracked as a user with an account. In at least some scenarios, but for the provision of accounts and system guardrails implemented by aspects of the online marketplace 112 (e.g., user interfaces of the application 110), the online marketplace 112 does not generally control actions of the users to use functionality of the online marketplace 112 to list items thereon. For instance, a number (e.g., most) of the users of the online marketplace 112 may not be employed by or otherwise similarly controlled by a company associated with the online marketplace 112. In this way, the users of the online marketplace 112 may exert more control over the items 116 listed with the online marketplace 112 (e.g., the items 116 that those users decide to list through the online marketplace 112) than the company associated with the online marketplace 112 (or its employees or agents).

Users that cause items 116 to be listed on the online marketplace 112 may be referred to as “sellers” (e.g., a seller 126) whereas users that purchase or otherwise obtain items 116 listed on the online marketplace 112 via its listings may be referred to as “buyers” (e.g., a buyer 128). Sellers 126 and buyers 128 both interact with user interfaces of the online marketplace 112 (e.g., via the application 110) to perform the desired functionality. In addition, an individual user of the online marketplace 112 can interact via the interfaces to be both a seller 126 and a buyer 128 on the online marketplace 112, such as by interacting with the user interfaces to have caused one or more items 116 to be listed on the online marketplace 112 and by interacting with the user interfaces to purchase one or more items 116 from the listings of the online marketplace 112.

A user that is a seller 126, for instance, may interact with one or more user interfaces of the online marketplace 112 (e.g., output via the application 110) to provide information about one or more items 116 which the seller 126 is causing to be listed on the online marketplace 112. Such user interfaces may include prompts that instruct, or guide, sellers 126 to provide various information about items 116 being listed. Examples of information that such interfaces prompt sellers 126 for and that those sellers 126 provide include, but are not limited to, a title, description (of the item 116), one or more prices (e.g., to purchase the item 116 now and/or a minimum starting bid for the item 116), brand information, size, year, color(s), shipping information (e.g., cost and/or types available), delivery information, return information, payment information, images, videos, models, authenticity information, item history (e.g., chain of custody), and condition (of the item 116), to name a few.

One or more portions of such information may be referred to herein as attributes 122 of the listing 114. For example, a title of the listing 114 may be an attribute 122 of the listing, a description of the item 116 being listed may be an attribute 122 of the listing 114, one or more images uploaded or selected for the listing 114 may be one or more attributes 122 of the listing 114, color(s) of the item 116 may be an attribute 122 of the listing 114, one or more categories 124 (e.g., product or item classes) of the item 116 may be attributes 122 of the listing 114, and so forth. The categories 124 may provide a way to organize inventory of the online marketplace.

In one or more implementations, the categories 124 of the online marketplace 112 include a category hierarchy (e.g., a tree structure) in which more specific child categories 124 (e.g., smartphones) fall under more generic parent categories 124, e.g., electronics. Additionally, or alternatively, the categories 124 of the online marketplace 112 include a plurality of sector categories 124 (e.g., sports) each including one or more highest-level or root categories 124 (e.g., sports memorabilia, sporting goods). Given this, the categories 124 associated with a listing 114 for an item 116 can include the categories 124 of the category hierarchy that the item 116 falls under (e.g., from the root category 124 to the lowest-level or leaf category 124), and one or more sector categories 124 to which the item 116 belongs.

In one or more implementations, the online marketplace 112 saves and maintains the input information for a listing 114 in the storage device 118 in fields of a data structure or data record populated for the listing 114, where a given field and the information populated and maintained for the given field correspond to a particular attribute 122 of the listing 114. For instance, a ‘title’ field of such a data structure or data record may be populated with information (e.g., text) input into a user interface by a seller of a listing 114. The title field and the information input by the user as the title of the listing 114 correspond to an attribute 122 of the listing 114, e.g., a title attribute. In one or more implementations, one or more of the attributes 122 of a listing 114 may be derived and then populated by the online marketplace 112, such as by the online marketplace 112 processing one or more portions of the information input by a user to populate one or more respective attributes of the listing 114.

The evidence relevance platform 106 may be designed for the process of contesting chargebacks (e.g., transaction disputes) between a seller 126 and a buyer 128 by leveraging a seller contest evidence evaluation system 134, which includes a VLM 136 and an LLM 140. The VLM 136 may be an example of a multi-modal model capable of processing different types of data (e.g., text, images, videos, audio) simultaneously. In addition, the VLM 136 which may enable the seller contest evidence evaluation system 134 to integrate image and text data to evaluate the quality and relevance of evidence provided by the seller 126 in response to dispute contestations.

A transaction 130 may occur between the seller 126 and the buyer 128 on the online marketplace 112. The transaction 130 may include any sale or purchase of items 116 on the online marketplace 112, including a purchase of software or a service. For example, the transaction 130 may include the buyer 128 purchasing an item 116 from the seller 126 (i.e., the seller 126 selling the item 116 to the buyer 128). The online marketplace 112 and the evidence relevance platform 106 may implement robust security measures to protect sensitive transaction data and personal information of users of the online marketplace 112. In some cases, the buyer 128 may file a dispute to the transaction 130, for example, if the buyer 128 believes the item 116 they received differs from how it is described in the listing 114. When filing the dispute, the buyer may submit information (e.g., messages) and other dispute context related to the item and the reasons the buyer is disputing the transaction 130. In response, the seller 126 may contest or challenge the dispute. To file a contestation, the seller 126 may provide contested dispute information 132 to the VLM 136 via the seller contest evidence evaluation system 134. The contested dispute information 132 may include information about the item 116 at issue and evidence related to the seller's defense, among other information. For example, the contested dispute information 132 may include any of the real-time listing data 120, particularly the listing 114. The listing 114 may include image and text data (e.g., images and descriptions of the item 116 at issue).

The contested dispute information 132 and the dispute context 138 may be provided to the seller contest evidence evaluation system 134. The VLM 136 may generate a summary of the contested dispute information 132. Because the VLM 136 is capable of processing both image evidence and text evidence included in the contested dispute information 132, the VLM 136 may effectively generate a text description (the summary) of the image evidence. For example, the summary may include a description of the item 116 actually sent to the buyer 128 and reasoning as to why the seller is contesting the dispute. The summary may also include a dispute context 138 provided by the buyer 128, which may include order information, a buyer note including buyer-submitted information (e.g., messages), the buyer's reason for disputing the transaction 130, and so forth.

A prompt may be generated for the LLM 140 to evaluate the relevance of the evidence provided by the user based on the summary of the contested dispute information 132 generated by the VLM 136 (including the image description produced by the VLM 136). The LLM 140 may be trained on the real-time listing data 120. To facilitate evidence relevance evaluation, the seller contest evidence evaluation system 134 and the LLM 140 may support an LLM agent (also referred to herein as an AI assistant). The LLM agent may evaluate the relevance of the evidence based on the prompt, which may include outputting a relevance score 142. By way of example, the relevance score may range from 1 to 10, where a higher score indicates that the evidence is more likely to help the seller 126 succeed in their contest). If the relevance score is below a threshold (e.g., under 5), indicating that the seller 126 is unlikely to effectively contest the dispute with the current evidence, the LLM agent may output suggestions regarding how the seller 126 may improve the relevance of the evidence. For example, if the seller 126 provided blurry images of the item 116 (to prove that the item 116 sold was the same as the item 116 described in the listing 114), the LLM agent may suggest that the seller 126 upload clearer images.

Having considered an example of an environment, consider now a discussion of some example details of the techniques for AI-based evaluation of seller-contested disputes in accordance with one or more implementations.

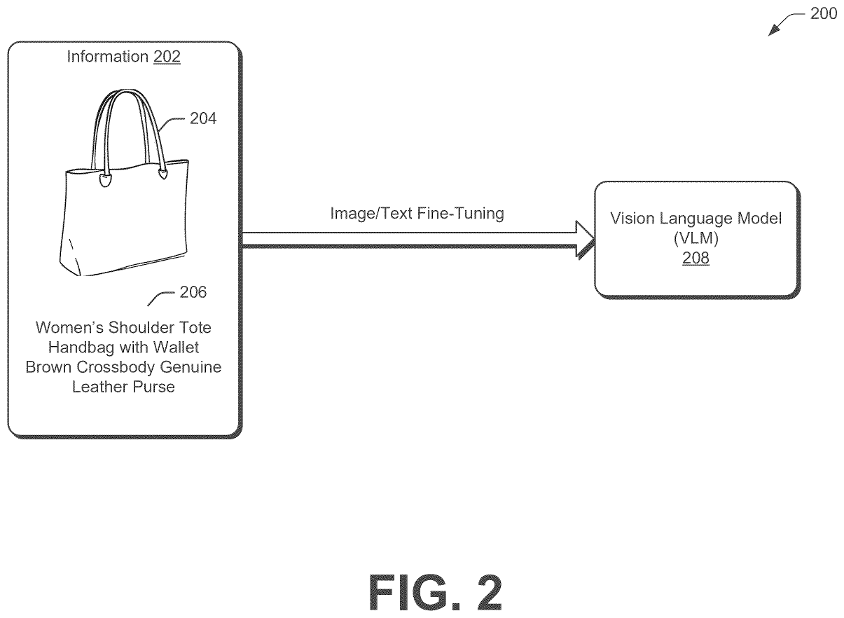

FIG. 2 depicts an example of a process 200 for fine-tuning a VLM in accordance with aspects of the present disclosure. The process 200 may be implemented in or otherwise supported by the computing device 102, the service provider system 104, and the evidence relevance platform 106, as described in FIG. 1. For example, the process 200 may be implemented and supported by a VLM 208, which may be an example of the VLM 136 described in FIG. 1. The process 200 may depict using image and text data provided by a seller when submitting information for a dispute contestation to fine-tune the VLM 208.

A seller may upload information 202 of an item (e.g., a handbag) sold to a buyer on an online marketplace. The information 202 may include visual (e.g., image) information and textual information. For example, the information 202 may include listing details of the item such as a listing image (e.g., an image 204), a description 206, and a reason for contesting the dispute, among other visual and textual information relating to the item at issue. In the example of FIG. 2, the description 206 may be “Women's Shoulder Tote Handbag with Wallet Brown Crossbody Genuine Leather Purse.” In some examples, the image 204 may be a stock image of the item for sale, for example, on a website from which the item was initially sold. The image 204 and the description 206 may be referred to as an image-text pair associated with the specific item.

The VLM 208 may support a vision capability for processing image information (e.g., the image 204) as well as a natural language capability for generating a text summary of the image. The VLM 208 may perform a multi-modal analysis of the information 202, which may include analyzing text from the information 202 (e.g., the description 206) and the images from the information 202 (e.g., the image 204). VLM 208 may function as a multi-modal model capable of processing and understanding images, texts, and other forms of data in a unified framework. To do so, the VLM 208 may support a vision encoder that utilizes a convolutional neural network (CNN) or a vision transformer (ViT) to extract features from uploaded images. The vision encoder captures visual elements such as item condition, packaging, and relevant documentation associated with the transaction (e.g., invoices, receipts, and so forth). To support such functionalities, the vision encoder may integrate optical character recognition (OCR) and other technologies to automatically verify documents such as receipts and invoices. In some implementations, the vision encoder may ingest and preprocess image data. For example, to preprocess images from the seller, the vision encoder may resize, normalize, and augment images as applicable.

The VLM 208 may also support a text encoder, which may be a transformer-based LLM that processes textual inputs including seller-provided descriptions, explanations, and responses associated with the seller's reasons for contesting a dispute. The text encoder may also preprocess the text data by tokenizing, cleaning, and formatting text inputs in order to extract semantic features (e.g., specific details about the listing, such as condition, shipping information, and so forth). In addition, the VLM 208 may include a fusion layer that combines features from both the vision and text encoders, enabling the VLM 208 to understand any form of evidence provided by the seller. The fusion layer may employ attention mechanisms to align and integrate multi-modal (e.g., image and text) data. The VLM 208 may also support multiple languages to process more images and text.

In some examples, the process 200 may include fine-tuning the VLM 208 to generate a summary of the information 202 and evaluate evidence relevance as described herein. Fine-tuning the VLM 208 may include pre-training the VLM 208 using a large dataset of paired images and text (image-text pairs). For example, the dataset may include paired images and text such as the image 204 and the description 206 or images and text corresponding to any other listings specific to the online marketplace. Such training may enable the VLM 208 to develop a general understanding of multi-modal data (e.g., image and text data). In addition, the VLM 208 may be fine-tuned on a curated dataset of chargeback cases, emphasizing specific nuances and requirements of evidence evaluation in the e-commerce domain. The pre-training and fine-tuning of the VLM 208 may reflect diverse cases and scenarios to ensure that the models' relevance evaluations and recommendations are unbiased and fair. In some examples, an initial VLM or another LLM may be used as a base model, where the VLM 208 may be the same model fine-tuned with data specific to the online marketplace to that the VLM 208 performs better for the online marketplace's listing image processing tasks.

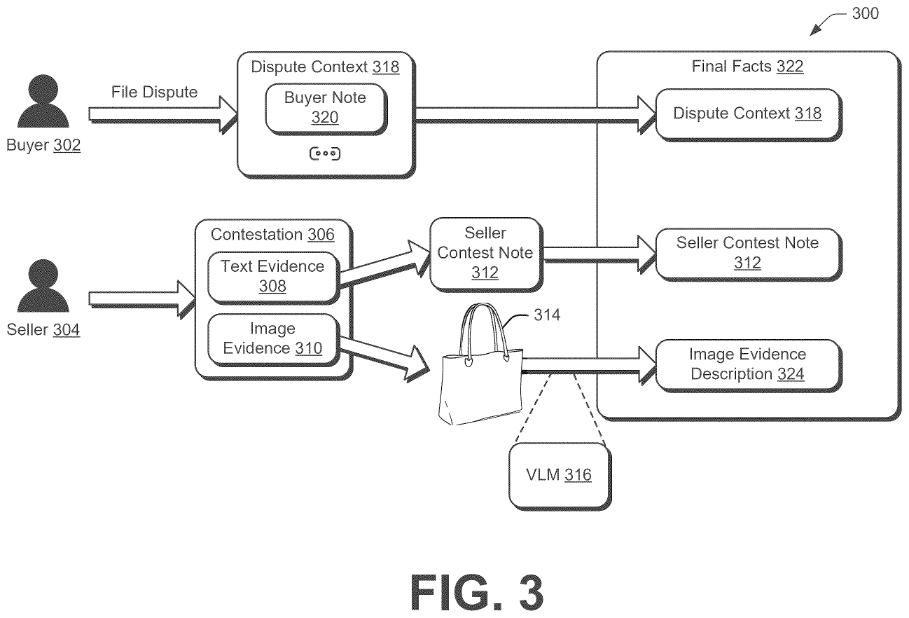

FIG. 3 depicts an example of a fact generation process 300 for in accordance with aspects of the present disclosure. The fact generation process 300 may be implemented in or otherwise supported by the computing device 102, the service provider system 104, the evidence relevance platform 106, and the seller contest evidence evaluation system 134, as described in FIG. 1. The fact generation process 300 may involve a VLM 316, which may be the VLM 208 of FIG. 2. The VLM 208 may generate final facts 322 about a contested dispute on an online marketplace based on various information provided by a buyer 302 and a seller 304 of an item.

As described herein, the buyer 302 may transact with the seller 304 on the online marketplace to purchase an item from the seller 304. The buyer 302 may file a dispute to the transaction for numerous reasons, for example, if the buyer 302 believes the item they received was significantly not as described in the listing. When filing the dispute, the buyer may provide dispute context 318. The dispute context 318 may include buyer-submitted information (e.g., messages) including order information, payment information, a buyer note 320, a dispute reason, and so forth. The buyer note 320, for example, may include messages from the buyer to the seller or to a customer service platform of the online marketplace explaining that the item they received was significantly not as described.

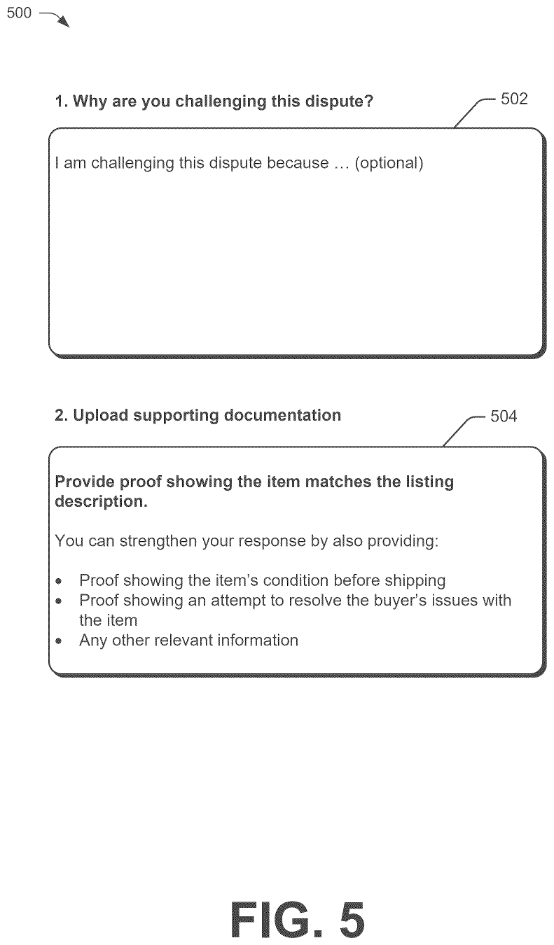

In response to the dispute, the seller 304 may file a contestation 306. For example, the seller 304 may file the contestation 306 if the seller 304 believes the item they sold was accurately described in the listing. The contestation may include evidence related to their defense, including text evidence 308 and image evidence 310. By way of example, the text evidence 308 may include a description of the item (as sold and/or as listed) and the image evidence 310 may include images of the actual item and listing images, which may be stock images of the item (e.g., from another platform where the item was originally sold). In some implementations, the seller 304 may upload the text evidence 308 and the image evidence 310 via a web or mobile application, such as the user interface 500 described in FIG. 5.

The text evidence 308 may be compiled into a seller contest note 312. In addition, the image evidence 310 may include an image 314 of the item (e.g., a handbag), which is provided to the VLM 316. The VLM 316 may be a customized VLM model (the VLM 208 of FIG. 2) that is fine-tuned with data specific to the online marketplace(e.g., listing images and descriptions). The VLM 316 may analyze the image 314 submitted by the seller 304 and generate a text summary of the image 314, an image evidence description 324. The image evidence description 324 may be included in the final facts 322, which may also include the dispute context 318 from the buyer 302 and the seller contest note 312.

The image evidence description 324 may enable the LLM to compare the image 314 against images in the original item listing (e.g., an image 204 of the information 202, as described in FIG. 2) to detect discrepancies between the images and assess the relevance of the image evidence 310. To do so, the VLM 316 may generate the final facts 322, which may be a summary of the seller contest note 312 and other information related to the dispute, such as the item listing.

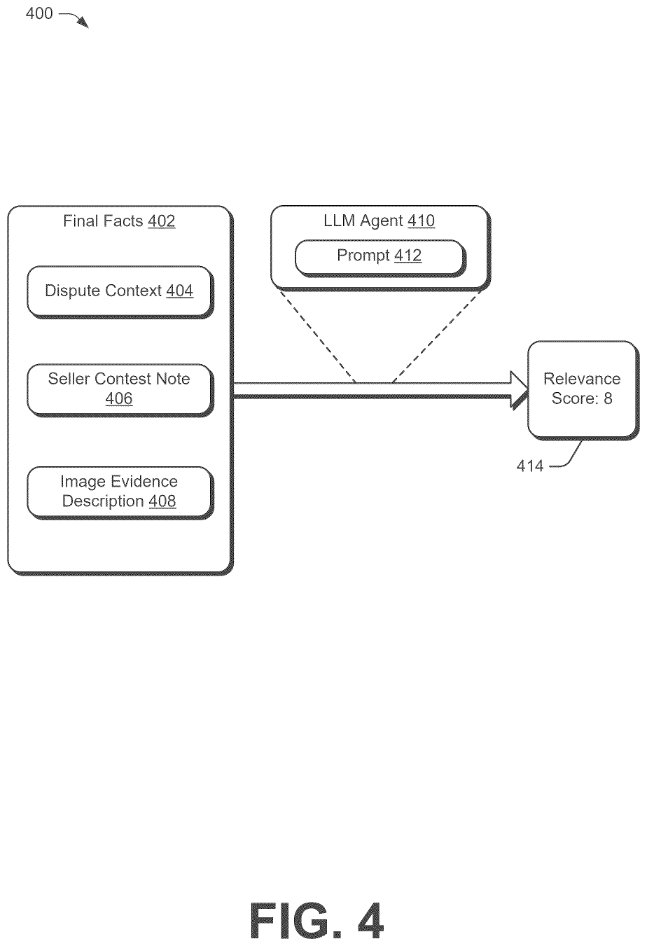

By way of example, the final facts 322 may include a dispute context 318, an image evidence description 324, and the seller contest note 312. The dispute context 318 may include information provided by the buyer 302 when filing the dispute, such as order information including the item description, e.g., Women's shoulder tote handbag with wallet brown crossbody genuine leather purse, the payment method, e.g., Visa, the buyer note 320, e.g., “I received a different item which is not as described, the dispute reason, e.g., significantly not as described, and so forth. The image evidence description 324 may be generated by the VLM 316 based on the image 314 in the seller contest note 312. For example, the image evidence description 324 may be “brown leather purse, crossbody style.” The seller contest note 312 may include text the seller 304 inputs when contesting the dispute explaining the text evidence 308 and the image evidence 310. For example, the seller contest note 312, as summarized in the final facts 322, may be “please see the image of the item I shipped, it's exactly the same as the description, and the buyer made a false claim!” The image 314 is the of the item the seller 304 shipped in such cases. As described in FIG. 4, the VLM 316 may use the final facts 322 to evaluate the relevance of the text evidence 308 and the image evidence 310.

FIG. 4 depicts an example of an evidence relevance evaluation process 400 in accordance with aspects of the present disclosure. The evidence relevance evaluation process 400 may be implemented in or otherwise supported by the computing device 102, the service provider system 104, and the evidence relevance platform 106, as described in FIG. 1. For example, the evidence relevance evaluation process 400 may be implemented in or supported by an LLM, such as the LLM 140 described in FIG. 1.

As described herein with reference to FIG. 3, a multi-modal model including an LLM and a VLM may generate final facts 402, which may be a summary of information provided by a seller when contesting a dispute on an online marketplace (e.g., contested dispute information). The final facts 402 may include a dispute context 404, which includes information provided by a buyer when filing a dispute to a transaction. For example, the dispute context 404 may include order information (e.g., an item description), a payment method, a buyer note including messages submitted from the buyer, a dispute reason, and so forth. In the example of FIG. 4, the buyer's dispute reason may be that the item received was significantly not as described. Additionally, or alternatively, the final facts 402 may include an image evidence description 406 generated by the LLM based on an image the seller provided of the actual item sold. Additionally, or alternatively, the final facts 402 may include a seller contest node 408, which may include text the seller input when contesting the dispute explaining the evidence they provided.

The LLM may use the final facts 402 to evaluate the relevance of the evidence provided by seller. Specifically, an LLM agent 410 (e.g., an AI assistant) supported by the LLM may receive a prompt 412. The prompt 412 may be based on the final facts 402 and may guide the LLM to evaluate a relevance of the evidence. In some implementations, the prompt 412 may contextualize the dispute for the LLM agent 410 by providing the final facts 402, i.e., background information related to the item description, listing details (e.g., an item description and title), a listing image, an evidence image (e.g., an image of the actual item purchased), transaction details (e.g., payment method), and the buyer's and seller's reasons for the dispute. In addition, the prompt 412 may guide the LLM and the LLM agent 410 to assess the relevance, clarity, and sufficiency of images and text uploaded by the seller as evidence of their defense (e.g., the text evidence 308 and the image evidence 310 of FIG. 3). Additionally, the prompt 412 may instruct the LLM agent 410 to generate constructive feedback and suggestions, identifying strengths and weaknesses in the provided evidence and suggesting improvements. By way of example, the prompt 412 may state “Given the chargeback reason of ‘Item Not as Described,’ evaluate the uploaded images and text description. Does the evidence adequately demonstrate the item's compliance with the description? If not, suggest additional evidence that could strengthen the seller's case.”

To assess the relevance of the evidence, the LLM agent 410 may support an evaluation and guidance system including an evaluation module and a guidance module. The evaluation model may utilize the fused multi-modal representation (e.g., and LLM and a VLM) to assess the quality and relevance of the evidence. The evaluation model may consider factors such as image clarity, completeness, relevance to the reason for the dispute, consistency within the item description (e.g., consistency between the listing description of the item and the actual item), and so forth. For example, the evaluation model may consider whether the image has a requisite image clarity, which may require a particular resolution (e.g., number of pixels), sharpness, contrast, signal-to-noise ratio (SNR) or other metrics. Completeness of the evidence may be evaluated based on how much evidence is provided compared to how much evidence is generally provided for similar disputes, how much supporting documentation the seller uploaded (e.g., the evidence may be incomplete if no supporting documentation, including images, is provided), and so forth.

A scoring mechanism may be used to quantify the evidence's strength. In some implementations, the LLM agent 410 may output a response to the prompt 412 indicating the result of the relevance evaluation, which may include a relevance score 414 and an explanation of the relevance evaluation. The relevance score 414 may be in a range from 1 to 10 (e.g., relevance score: 8), where a low relevance score (e.g., under 5) may indicate that the evidence provided is insufficient to successfully contest the dispute, and a high relevance score (e.g., 5 and greater) indicates that the evidence provided is sufficient to contest the dispute.

Based on the results of the evaluation, the guidance module of the evaluation and guidance system may generate specific guidance for the seller. Accordingly, the LLM agent 410 may highlight missing or unclear evidence, suggest additional documentation (e.g., clearer images, proof of delivery), provide tips on presenting evidence more effectively (e.g., focusing on key aspects, improving text clarity), and so forth. For example, if the evidence included blurry or otherwise poor-quality images of the item the LLM agent 410 may suggest that the seller upload clearer images. If the seller merely explains that the image of the item shipped is exactly the same as the image in the item listing, the LLM agent 410 may suggest that the seller add additional information specifying the similarities. In this way, the LLM agent 410 may provide real-time feedback and suggestions to sellers as soon as sellers upload and describe evidence related to a dispute.

In some examples, the LLM agent 410 may support predictive models that estimate the likelihood of winning a contested dispute based on historic data and the provided evidence. For example, if the relevance score 414 is above a threshold (e.g., 7 or higher), then the LLM agent 410 may estimate that the seller is likely to succeed in the contestation. Alternatively, if the relevance score 414 is below a threshold (e.g., 3 or lower), then the LLM agent 410 may estimate that the seller is not likely to succeed.

FIG. 5 depicts an example of a user interface 500 in accordance with aspects of the present disclosure. The user interface 500 may be implemented in or otherwise supported by the computing device 102, the service provider system 104, and the evidence relevance platform 106, as described in FIG. 1. For example, the user interface 500 may enable a seller (e.g., a seller 126) to challenge a dispute made by a buyer regarding a transaction on an online marketplace.

The user interface 500 may include a field 502 and a field 504. The field 502 may ask a seller “Why are you challenging this dispute?” and the seller may input optional text explaining their reasoning for challenging the dispute. For example, the seller may input “I am challenging this dispute because the item I shipped is exactly the same as the listing description.” The field 502 may be a structured field in which the seller may provide detailed descriptions and responses related to the dispute.

In addition, the seller may upload supporting documentation or evidence in the field 504. The field 504 may be a user-friendly interface for uploading images and other supporting documentation. For example, the seller may provide proof showing that the item they shipped matches the listing description. In some examples, based on evaluating relevance of the seller's evidence, an LLM (e.g., via an LLM agent or an AI assistant) may provide the seller with suggestions for improving the strength and relevance of their evidence, which may increase the likelihood that the seller will win the dispute. For example, the LLM may indicate that the seller may strengthen their response to the dispute by also providing proof showing the item's condition before shipping, proof showing an attempt to resolve the buyer's issues with the item, or any other relevant information. The LLM may evaluate the relevance of the seller's evidence in real-time and provide a relevance score to the seller via the user interface 500.

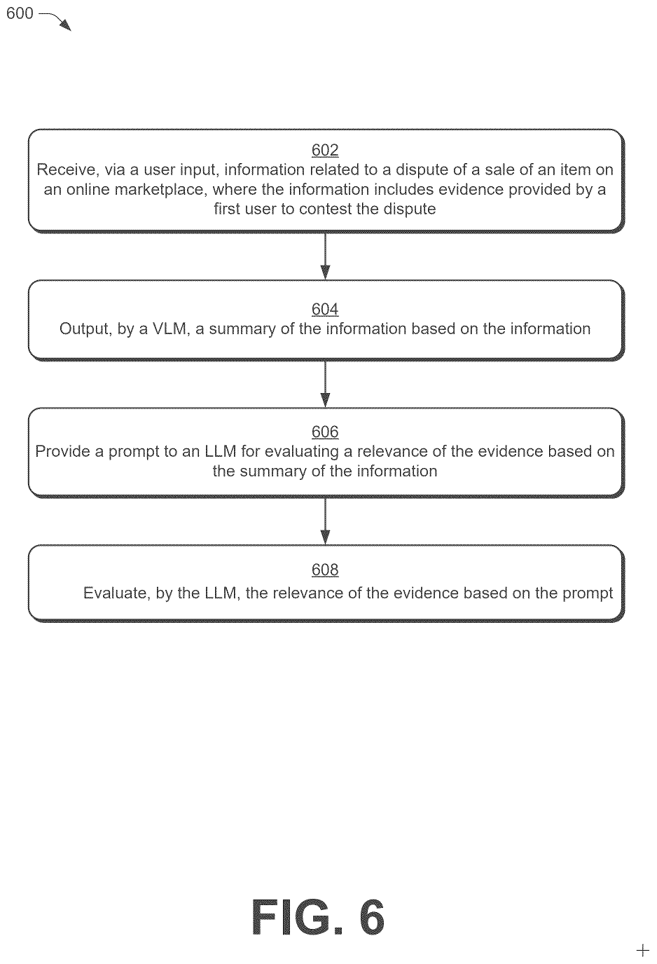

FIG. 6 depicts a procedure 600 in an example implementation of AI-based evaluation of a seller-contested dispute in accordance with aspects of the present disclosure.

Information related to a dispute of a sale of an item on an online marketplace is received via a user input from a first user, where the information includes evidence provided by the first user to contest the dispute (block 602). By way of example, a seller 126 may provide contested dispute information 132 to a VLM 136, where the evidence includes supporting documentation and image and text information such as a reason for the seller's challenge to the dispute and images of an item 116 the seller shipped.

A summary of the information may be output by a VLM based on the information (block 604). By way of example, the VLM 136 may process text and image data included in the information and generate a summary that distills facts associated with the dispute (e.g., generates a text summary based on the images).

A prompt is provided to an LLM for evaluating a relevance of the evidence based on the summary of the information (block 606). By way of example, the prompt may instruct the LLM 140 to assess factors such as image clarity and completeness of the evidence to determine if the evidence is sufficiently relevant and strong for the seller 126 to effectively contest the dispute.

The relevance of the evidence is evaluated based on the prompt (block 608). By way of example, an LLM agent supported by the LLM 140 may output a response to the prompt indicating how relevant the evidence is to the dispute. In some implementations, the LLM agent may generate a relevance score 142 indicating whether the evidence provided is sufficient for the seller 126 to effectively contest the dispute.

Having described examples of procedures in accordance with one or more implementations, consider now an example of a system and device that can be utilized to implement the various techniques described herein.

FIG. 7 illustrates an example of a system 700 generally that includes an example of a computing device 702 that is representative of one or more computing systems and/or devices that may implement the various techniques described herein. This is illustrated through inclusion of the application 110 and the evidence relevance platform 106. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interfaces 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 706 is illustrated as including memory/storage 712. The memory/storage 712 represents memory/storage capacity associated with one or more computer-readable media. The memory/storage 712 may include volatile media (such as random access memory (RAM)) and/or nonvolatile media (such as read only memory (ROM), Flash memory, optical disks, magnetic disks, and so forth). The memory/storage 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device embodiment, implementation of functionality described herein may be distributed throughout the system 700. For example, the functionality may be implemented in part on the computing device 702 as well as via the platform 716 that abstracts the functionality of the cloud 714.

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

1. A computer-implemented method comprising:
receiving, via a user input from a first user, information related to a dispute of a sale of an item on an online marketplace, wherein the information comprises image data and text data provided by the first user to contest the dispute;
extracting, by a vision encoder of a first machine learning model comprising a vision language model (VLM), visual features from the image data and extracting, by a text encoder of the first machine learning model comprising the VLM, semantic features from the text data, wherein the VLM is trained using a set of image-text pairs;
generating, by the VLM and using a fusion layer that employs mechanisms of the vision encoder and the text encoder, a contextual summary of the information based on the information visual features and the semantic features;
providing, to a second machine learning model comprising a large language model (LLM), a prompt comprising the contextual summary, wherein the prompt instructs the LLM to evaluate a relevance of the information to contesting the dispute based on the contextual summary;
evaluating, by the LLM, the relevance of the information based on the prompt; and
providing, via a user interface associated with the online marketplace, a response having a result of the evaluating.

2. The computer-implemented method of claim 1, further comprising outputting, by the LLM, a response to the prompt, wherein the response indicates a relevance score and an explanation associated with the relevance.

3. The computer-implemented method of claim 2, wherein a low relevance score indicates that the information is insufficient for the first user to effectively contest the dispute, and wherein a high relevance score indicates that the information is sufficient for the first user to effectively contest the dispute.

4. The computer-implemented method of claim 2, further comprising generating, by the LLM, a suggestion for improving the relevance of the information based on a low relevance score.

5. The computer-implemented method of claim 2, further comprising estimating, by the LLM, a likelihood that the first user would win the dispute based on the information and historical data.

6. The computer-implemented method of claim 1, wherein evaluating the relevance of the information comprises assessing factors including at least image clarity, completeness, applicability to a reason for contesting the dispute, or consistency between the item itself and a listing description of the item.

7. The computer-implemented method of claim 1, wherein the information further comprises listing details of the item, a listing image of the item, and a reason for contesting the dispute.

8. The computer-implemented method of claim 1, wherein the prompt comprises one or more of listing details of the item, a listing image of the item, an evidence image of the item provided by the first user, a reason for disputing the sale provided by a second user, and a reason for contesting the dispute provided by the first user.

9. The computer-implemented method of claim 6, wherein the reason for disputing the sale is that the item was significantly not as described.

10. The computer-implemented method of claim 1, further comprising:
receiving, via a user input from a second user, an indication of the dispute, wherein the information is received in response to the indication.

11. The computer-implemented method of claim 1, wherein the fusion layer integrates the information processed by the vision encoder and the text encoder.

12. The computer-implemented method of claim 1, wherein the first user is a seller of the item and a second user is a buyer of the item on the online marketplace, and wherein the dispute is between the first user and the second user.

13. A system comprising:
one or more processors; and
memory storing instructions that, when executed by the one or more processors, cause the system to:
receive, via a user input from a first user, information related to a dispute of a sale of an item on an online marketplace, wherein the information comprises image data and text data provided by the first user to contest the dispute;
extract, by a vision encoder of a first machine learning model comprising a vision language model (VLM), visual features from the image data and extracting, by a text encoder of the first machine learning model comprising the VLM, semantic features from the text data, wherein the VLM is trained using a set of image-text pairs;
generate, by the VLM and using a fusion layer that employs mechanisms of the vision encoder and the text encoder, a contextual summary of the information based on the visual features and the semantic features;
providing, to a second machine learning model comprising a large language model (LLM), a prompt comprising the contextual summary, wherein the prompt instructs the LLM to evaluate a relevance of the information to contesting the dispute based on the contextual summary;
evaluate, by the LLM, the relevance of the information based on the prompt; and
provide, via a user interface associated with the online marketplace, a response having a result of the evaluating.

14. The system of claim 13, wherein the instructions further cause the system to execute, by the LLM, a response to the prompt, wherein the response indicates a relevance score and an explanation associated with the relevance.

15. The system of claim 14, wherein a low relevance score indicates that the information is insufficient for the first user to effectively contest the dispute, and wherein a high relevance score indicates that the information is sufficient for the first user to effectively contest the dispute.

16. The system of claim 14, wherein the instructions further cause the system to generate, by the LLM, a suggestion for improving the relevance of the information based on a low relevance score.

17. The system of claim 14, wherein the instructions further cause the system to estimate, by the LLM, a likelihood that the first user would win the dispute based on the information and historical data.

18. The system of claim 13, wherein evaluating the relevance of the information comprises assessing factors including at least image clarity, completeness, applicability to a reason for contesting the dispute, or consistency between the item itself and a listing description of the item.

19. The system of claim 13, wherein the information further comprises listing details of the item, a listing image of the item, and a reason for contesting the dispute.

20. A non-transitory computer-readable media storing instructions that, when executed by one or more processors, cause the one or more processors to perform operations including:
receiving, via a user input from a first user, information related to a dispute of a sale of an item on an online marketplace, wherein the information comprises image data and text data provided by the first user to contest the dispute;
extracting, by a vision encoder of a first machine learning model comprising a vision language model (VLM), visual features from the image data and extracting, by a text encoder of the first machine learning model comprising the VLM, semantic features from the text data, wherein the VLM is trained using a set of image-text pairs;
generating, by the VLM and using a fusion layer that employs mechanisms of the vision encoder and the text encoder, a contextual summary of the information based on the visual features and the semantic features;
providing, to a second machine learning model comprising a large language model (LLM), a prompt comprising the contextual summary, wherein the prompt instructs the LLM to evaluate a relevance of the information to contesting the dispute based on the contextual summary;
evaluating, by the LLM, the relevance of the information based on the prompt; and
providing, via a user interface associated with the online marketplace, a response having a result of the evaluating.
